(19) United States
(12) Patent Application Publication
(10) Pub. No.: US 2008/0059676 A1
(43) Pub. Date: Mar. 6, 2008

(54) EFFICIENT DEFERRED INTERRUPT HANDLING IN A PARALLEL COMPUTING ENVIRONMENT

(76) Inventors: Charles Jens Archer, Rochester, MN (US); Michael Alan Blocksome, Rochester, MN (US); Todd Alan Inglett, Rochester, MN (US); Derek Lieber, Yorktown Heights, NY (US); Patrick Joseph McCarthy, Rochester, MN (US); Michael Basil Mundy, Rochester, MN (US); Jeffrey John Parker, Rochester, MN (US); Joseph D. Ratterman, Rochester, MN (US); Brian Edward Smith, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/469,077

(22) Filed: Aug. 31, 2006

(51) Int. Cl. G06F 13/24

(52) U.S. Cl. 710/260

(57) ABSTRACT

Embodiments of the present invention provide techniques for protecting critical sections of code being executed in a lightweight kernel environment suited for use on a compute node of a parallel computing system. These techniques avoid the overhead associated with a full kernel mode implementation of a network layer, while also allowing network interrupts to be processed without corrupting shared memory state. In one embodiment, a fast user-space function sets a flag in memory indicating that interrupts should not progress and also provides a mechanism to defer processing of the interrupt.

### BACKGROUND OF THE INVENTION

1. Field of the Invention

The present invention generally relates to parallel computing. More specifically, the present invention relates to interrupt handling in a parallel computing system.

2. Description of the Related Art

One approach to developing powerful computer systems is to design highly parallel systems where the processing activity of hundreds, if not thousands, of processors (CPUs) may be coordinated to perform computing tasks. These systems have proved to be highly useful for a broad variety of applications including, financial modeling, hydrodynamics, quantum chemistry, astronomy, weather modeling and prediction, geological modeling, prime number factoring, image processing (e.g., CGI animations and rendering), to name but a few examples.

One family of parallel computing systems has been (and continues to be) developed by International Business Machines (IBM) under the name Blue Gene®. The Blue Gene/L system is a scalable system that may be configured with a maximum of 65,536 (2¹⁶) compute nodes. Each compute node includes a single application specific integrated circuit (ASIC) with 2 CPU's and memory. The Blue Gene architecture has been successful and on Oct. 27, 2005, IBM announced that a Blue Gene/L system had reached an operational speed of 280.6 teraflops (280.6 trillion floating-point operations per second), making it the fastest computer in the world at that time. Further, as of June 2005, Blue Gene/L installations at various sites world-wide were among 5 out of the 10 top most powerful computers in the world.

IBM is currently developing a successor to the Blue Gene/L system, named Blue Gene/P. Blue Bene/P is expected to be the first computer system to operate at a sustained 1 petaflops (1 quadrillion floating-point operations per second). Like the Blue Gene/L system, the Blue Gene/P system is a scalable system with a projected maximum of 73,728 compute nodes. Each compute node in Blue Gene/P is projected to include a single application specific integrated circuit (ASIC) with 4 CPU's and memory. A complete Blue Gene/P system is projected to include 72 racks with 32 node boards per rack. In addition to the Blue Gene architecture developed by IBM, other highly parallel computer systems have been (and are being) developed.

In building these massively parallel systems, the operating system kernel running on each compute node is simplified as much as possible, in which case the kernel is referred to as “lightweight”. In some cases, however, the simplicity provided by a lightweight kernel environment may prevent common operations or functions from operating properly. For example, C library system calls should be generally re-entrant. Generally, a re-entrant function allows the same copy of a program or routine to be used concurrently by two or more tasks. Blue Gene/L, however, was originally designed to run without interrupts and without threads, so the locking mechanisms provided by the C library were unused. Functions in the C library, such as malloc( ), were non-reentrant, but contained empty macros to protect critical sections. A critical section is a set of instructions that should not be interrupted by asynchronous events (e.g., the delivery of an interrupt) or that are otherwise non-reentrant. On other platforms, such as the full kernel environment used by most Linux® distributions and AIX, the macros contain calls to pthread_mutex( ) or other locking calls, so critical sections could not be reentered.

To allow a main application to receive and process an interrupt, critical sections of code must be protected. However, the lightweight kernel on a compute node does not include the locking structures available from a full thread package (e.g., an implementation of the POSIX Pthreads package). Further, the main application context (the user application running on a compute node) and the interrupt or second context running on a compute node may share some state data (e.g., variables in memory), and this state data needs to be protected when executing non-reentrant critical sections. Two common reentrancy problems occur when moving to interrupt driven communication in a lightweight kernel environment. First, when a network packet arrives at a compute node, an interrupt is delivered. The user code executed to clear the interrupt may call a libc function (e.g., malloc( )) to allocate storage on the node for the network data. If the main application was executing a call to malloc( ) when the interrupt was delivered, then data corruption is likely to occur. A second situation occurs when the main application is advancing the network hardware through polling and a packet arrives (generating an interrupt). The network code to clear the interrupt also polls the network hardware, which is likely to cause corruption of the network state.

One approach to these (and other reentrancy problems) would be to provide a full threaded kernel or an interrupt handler, however, this approach requires the operating system running on each compute node to include an interrupt handler, a thread scheduler, and other components which reduces the overall processing efficiency of the parallel system otherwise provided by so-called lightweight kernels.

Accordingly, there remains a need for a method for protecting critical sections of code and handling interrupt driven communications on a compute node in a parallel computing system.

### SUMMARY OF THE INVENTION

Embodiments of the invention provide techniques for both efficient deferred interrupt handling as well as fast interrupt disabling and processing in a parallel computing environment. A very lightweight mechanism is used for delivering interrupts directly to user code that also provides the full safety of locks, without requiring the addition and overhead of a full threading package and thread scheduler.

One embodiment of the invention includes a method for deferred interrupt handling by a compute node running a user application in a parallel computing environment. The method generally includes initializing a shared memory state data structure and registering a deferred function to process an interrupt received while the user application is executing a wherein the critical section includes at least an instruction that modifies a shared memory value. The method may also include, upon entering the critical section, setting a shared memory flag of the shared memory data structure to indicate that the user application is currently inside the critical section.

Another embodiment of the invention include a computer-readable medium containing a program which, when executed, performs an operation for deferred interrupt handling by a compute node running a user application in a parallel computing environment. The operation generally includes initializing a shared memory state data structure and registering a deferred function to process an interrupt received while the user application is executing a critical section wherein the critical section includes at least an instruction that modifies a shared memory value. The operation may also include, upon entering the critical section, setting a shared memory flag of the shared memory data structure to indicate that the user application is currently inside a critical section.

Another embodiment of the invention includes a system having a compute node having at least one processor and a memory coupled to the compute node and configured to store, a shared memory data structure and a lightweight kernel. The system may generally further include a user application configured to initialize a shared memory state data structure, register a deferred function to process an interrupt received while the user application is executing a critical section, wherein the critical section includes at least an instruction that modifies a shared memory value, and upon entering the critical section, and set a shared memory flag of the shared memory data structure to indicate that the user application is currently inside a critical section.

Another embodiment of the invention includes a method for deferred interrupt handling by a compute node running a user application in a parallel computing environment. This method generally includes initializing a shared memory state data structure, registering a deferred function to process an interrupt received while the user application is executing a critical section, wherein the critical section includes at least an instruction that modifies a shared memory value, and upon entering the critical section, setting a shared memory flag of the shared memory data structure to indicate that the user application is currently inside the critical section. This method may also include, upon exit from the critical section, clearing the shared memory flag, evaluating a pending flag of the shared memory data structure, and, if the pending flag indicates that an interrupt was deferred while executing the critical section, invoking the deferred function to clear the interrupt.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating components of a massively parallel computer system, according to one embodiment of the invention.

FIG. 2 is a block diagram illustrating an exemplary system build up of a massively parallel computer system, according to one embodiment of the invention.

FIG. 3 is a block diagram illustrating an exemplary compute node within a massively parallel computer system, according to one embodiment of the invention.

FIGS. 4A-4B are conceptual diagrams illustrating topologies of compute node interconnections in a massively parallel computer system, according to one embodiment of the invention.

FIG. 5 illustrates elements of a data structure used for deferred interrupt handling in a parallel computing environment, according to one embodiment of the invention.

FIGS. 6A-6B illustrate processing flow for a thread executing on a compute node of a massively parallel computer system, according to one embodiment of the invention.

FIGS. 7A-7D illustrate aspects of a method for deferred interrupt handling in a parallel computing environment, according to one embodiment of the invention.

FIGS. 8A-8B illustrate processing flow for a thread executing on a compute node of a massively parallel computer system, according to one embodiment of the invention.

FIG. 9 illustrates a method for fast interrupt disabling and processing in a parallel computing environment, according to one embodiment of the invention.

### DETAILED DESCRIPTION OF THE PREFERRED EMBODIMENTS

Embodiments of the present invention provide techniques for protecting critical sections of code being executed in a lightweight kernel environment. These techniques operate very quickly and avoid the overhead associated with a full kernel mode implementation of a network layer, while also allowing network interrupts to be processed without corrupting shared memory state. Thus, embodiments of the invention are suited for use in large, parallel computing systems, such as the Blue Gene® system developed by IBM®.

In one embodiment, a system call may be used to disable interrupts upon entry to a routine configured to process an event associated with the interrupt. For example, a user application may poll network hardware using an advance( ) routine, without waiting for an interrupt to be delivered. When the advance( ) routine is executed, the system call may be used to disable the delivery of interrupts entirely. If the user application calls the advance( ) routine, then delivering an interrupt is not only unnecessary (as the advance( ) routine is configured to clear the state indicated by the interrupt), but depending on timing, processing an interrupt could easily corrupt network state. At the same time, because the network hardware preserves interrupt state and will continually deliver the interrupt until the condition that caused the interrupt is cleared, an interrupt not cleared while in the critical section will be redelivered after the critical section is exited and interrupts are re-enabled.

In some cases, however, the use of a system call may incur an unacceptable performance penalty; particularly for critical sections that do not invoke other system calls. For example, incurring the overhead of a system call each time a libc function is invoked (e.g., malloc( )) may be too high. Instead of invoking a system call at the start of such functions to disable interrupts and another on the way out to re-enable interrupts, an alternative embodiment invokes a fast user-space function to set a flag in memory indicating that interrupts should not progress and also provides a mechanism to defer processing of the interrupt. Both of these embodiments are described in greater detail below.

Additionally, embodiments of the invention are described herein with respect to the Blue Gene massively parallel architecture developed by IBM. Embodiments of the invention are advantageous for massively parallel computer systems that include thousands of processing nodes, such as a Blue Gene system. However, embodiments of the invention may be adapted for use by a variety of parallel systems that employ CPUs running lightweight kernels and that are configured for interrupt driven communications. For example, embodiments of the invention may be readily adapted for use in distributed architectures such as clusters or grids where processing is carried out by compute nodes running lightweight kernels.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM or DVD-ROM disks readable by a CD- or DVD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

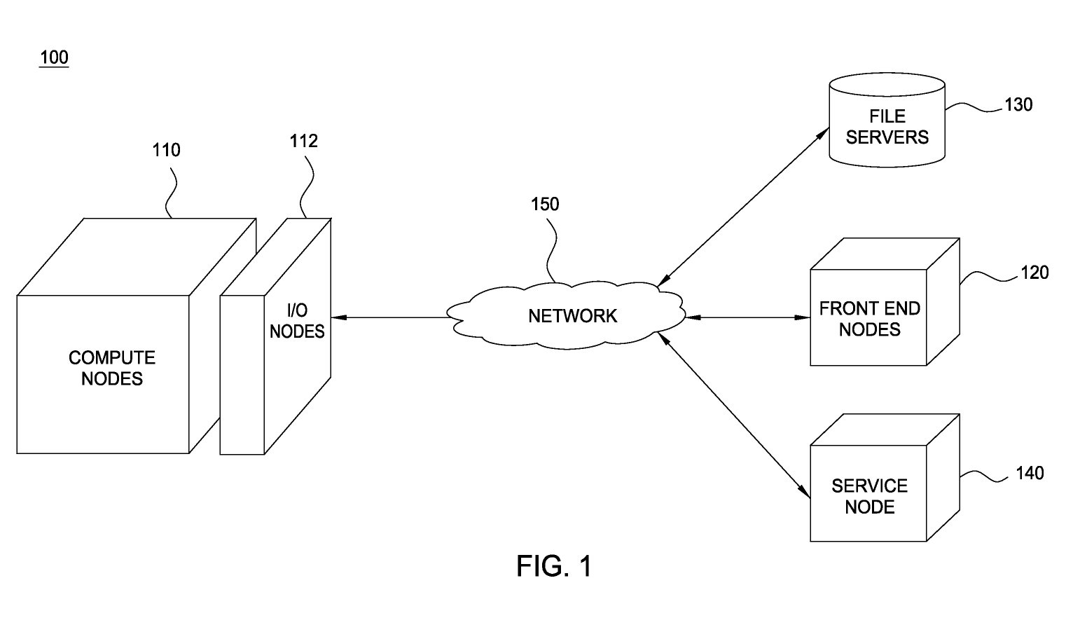

FIG. 1 is a block diagram illustrating components of a massively parallel computer system, according to one embodiment of the invention. In particular, computer system 100 provides a simplified diagram of a parallel system configured according to the Blue Gene architecture developed by IBM. However, system 100 is representative of other massively parallel architectures.

As shown, the system 100 includes a collection of compute nodes 110 and a collection of input/output (I/O) nodes 112. The compute nodes 110 provide the computational power of the computer system 100. Each compute node 110 may include one or more central processing units (CPUs). Additionally, each compute node 110 may include a memory store used to store program instructions and data sets (i.e., work units) on which the program instructions are performed. In a fully configured Blue Gene/L system, for example, 65,536 compute nodes 110 run user applications, and the ASIC for each compute node includes two PowerPC® CPUs (the Blue Gene/P architecture includes four CPUs per node).

Many data communication network architectures are used for message passing among nodes in a parallel computer system 100. Compute nodes 110 may be organized in a network as a torus, for example. Also, compute nodes 110 may be organized as a tree. A torus network connects the nodes in a three-dimensional mesh with wrap around links. Every node is connected to its six neighbors through the torus network, and each node is addressed by an <x, y, z> coordinate. In a tree network, nodes are often connected as a binary tree: each node has a parent, and two children. Additionally, parallel system may employ network communication channels for multiple architectures. For example, in a system using a torus and a tree network, the two networks may be implemented independently of one another, with separate routing circuits, separate physical links, and separate message buffers.

I/O nodes 112 provide a physical interface between the compute nodes 110 and file servers 130, front end nodes 120 and service nodes 140. Communication may take place over a network 150. Additionally, compute nodes 110 may be configured to pass messages over a point-to-point network. In a Blue Gene/L system, for example, 1,024 nodes 112 each manage communications for a group of 64 compute nodes 110. The I/O nodes 112 provide access to the file servers 130, as well as socket connections to processes in other systems. When a compute process on a compute node 110 performs an I/O operation (e.g., a read/write to a file), the operation is forwarded to the I/O node 112 managing that compute node 110. The managing I/O node 112 then performs the operation on the file system and returns the result to the requesting compute node 110. In a Blue/Gene L system, the I/O nodes 112 include the same ASIC as the compute nodes 112, with added external memory and an Ethernet connection.

Additionally, I/O nodes 112 may be configured to perform process authentication and authorization, job accounting, and debugging. By assigning these functions to I/O nodes 112, a lightweight kernel running on each compute node 110 may be greatly simplified as each compute node 110 is only required to communicate with a few I/O nodes 112. The front end nodes 120 store compilers, linkers, loaders and other applications used to interact with the system 100. Typically, users access front end nodes 120, submit programs for compiling, and submit jobs to the service node 140.

The service node 140 may include a system database and a collection of administrative tools provided by the system 100. Typically, the service node 140 includes a computing system configured to handle scheduling and loading of software programs and data on compute nodes 110. In one embodiment, the service node 140 may be configured to assemble a group of compute nodes 110 (referred to as a block), and dispatch a job to a block for execution.

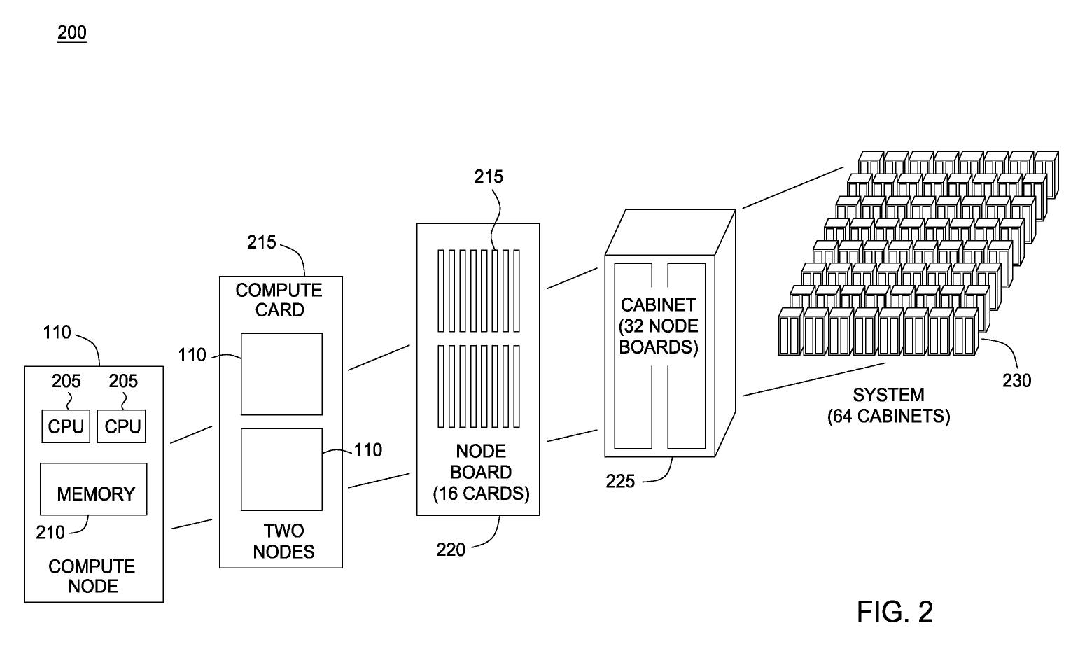

FIG. 2 is a block diagram illustrating an exemplary system build up of a parallel computer system 200, according to one embodiment of the invention. More specifically, FIG. 2 illustrates a system build up of a Blue Gene/L system. The systems-level design of the Blue Gene/L system includes two compute nodes 110 on a node card 215. Each compute node 110 includes two CPUs 205 and a memory 210. Compute cards 215 are assembled on a node board 220, 16 compute cards per node board 215, and eight node boards per 512-node midplane. Along with two midplanes, 31 node boards 220 are assembled into a cabinet 225 (for a total of 32 node boards per cabinet 225). A complete Blue Gene/L 230 system includes 64 cabinets.

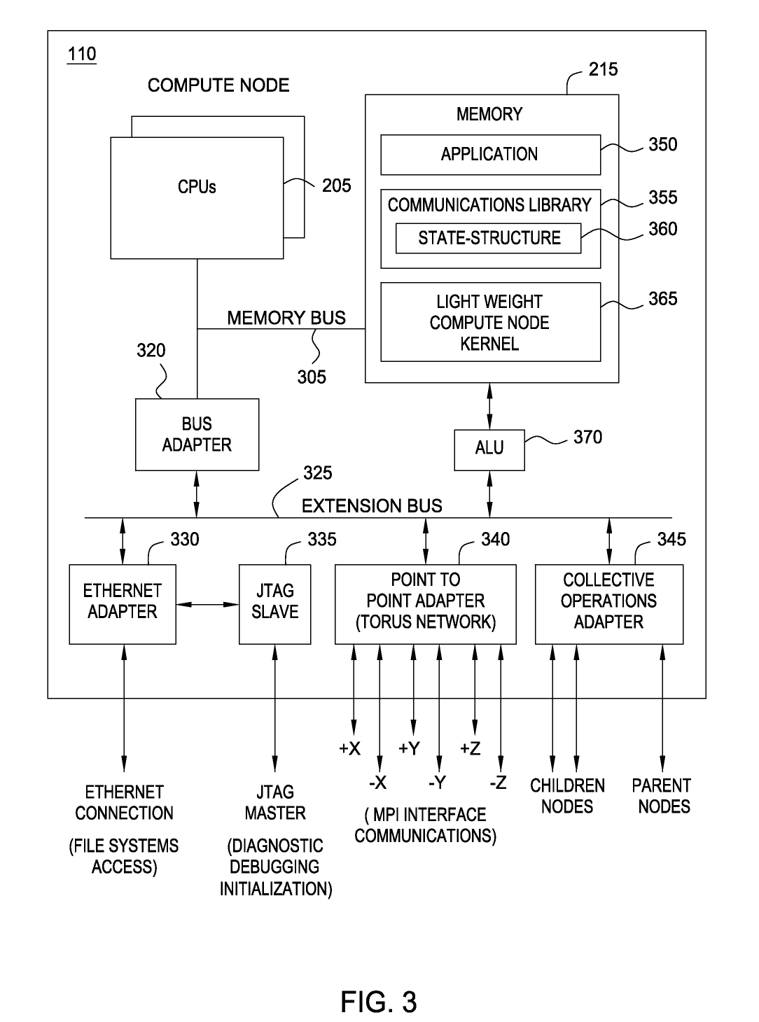

FIG. 3 is a block diagram illustrating aspects an exemplary compute node 110 of a massively parallel computer system, according to one embodiment of the invention. As shown, the compute node 110 includes CPUs 205, memory 215, a memory bus 305, a bus adapter 320, an extension bus 325 and network connections 330, 335, 340, and 345. CPUs 205 are connected to memory 215 over memory bus 305 and to other communications networks over bus adapter 320 and extension bus 325. Illustratively, memory 215 stores a user application 350, a communications library 355, and a lightweight compute node kernel 365. In one embodiment, one CPU 205 per node 110 is used for computation while the other handles messaging; however, both CPUs 205 may be used for computation if there is no need for a dedicated communication in the application 350.

The compute node operating system is a simple, single-user, and lightweight compute node kernel 365, which may provide a single, static, virtual address space to one user application 350 and a user level communications library 355 that provides access to networks 330-345. Known examples of parallel communications library 355 include the ‘Message Passing Interface’ (‘MPI’) library and the ‘Parallel Virtual Machine’ (‘PVM’) library.

In one embodiment, parallel communications library 355 includes routines used for both efficient deferred interrupt handling and fast interrupt disabling and processing by compute node 110, when the node is executing critical section code included in application 350. Additionally, communications library may define a state structure 360 used to determine whether user application 350 is in a critical section of code, whether interrupts have been disabled, or whether interrupts have been deferred, for a given critical section.

Typically, user application program 350 and parallel communications library 355 are executed using a single thread of execution on compute node 110. Because the thread is entitled to access to all resources of node 110, the quantity and complexity of tasks to be performed by lightweight kernel 365 are smaller and less complex that those of a kernel running an operating system on a computer with many threads running simultaneously. Kernel 365 may, therefore, be quite lightweight when compared to operating system kernels used for general purpose computers. Operating system kernels that may usefully be improved, simplified, or otherwise modified for use in a compute node 110 include versions of the UNIX®, Linux®, IBM's AIX® and i5/OS® operating systems, and others, as will occur to those of skill in the art.

As shown in FIG. 2, compute node 110 includes several communications adapters (330, 335, 340, and 345). Data communications adapters in the example of FIG. 2 include an Ethernet adapter 330 that couples compute node 110 to an Ethernet network. Gigabit Ethernet is a network transmission standard, defined in the IEEE 802.3 standard, that provides a data rate of 5 1 billion bits per second (one gigabit). JTAG slave 335 couples compute node 110 for data communications to a JTAG Master circuit. JTAG is the usual name used for the IEEE 1149.1 standard entitled Standard Test Access Port and Boundary-Scan Architecture for test access ports used for testing printed circuit boards using boundary scan. JTAG is used for printed circuit boards, as well as conducting boundary scans of integrated circuits, and is also useful as a mechanism for debugging embedded systems, providing a convenient “back door” into the system.

Point-to-point adapter 340 couples compute node 110 to other compute nodes in parallel system 100. In a Blue Gene/L system, for example, the compute nodes 110 are connected using a point-to-point a network configured as a three-dimensional torus. Accordingly, point-to-point adapter 340 provides data communications in six directions on three communications axes, x, y, and z, through six bidirectional links: +x and −x, +y and −y, +z and −z. Point-to-point adapter 340 allows application 350 to communicate with applications running on other compute nodes by passing a message that hops from node to node until reaching a destination. While a number of message passing models exist, the Message Passing Interface (MPI) has emerged currently dominant one. Many applications have been ported to, or developed for, the MPI model making it useful for a Blue Gene system.

Collective operations adapter 345 couples compute node 110 to a network suited for collective message passing operations. Collective operations adapter 345 provides data communications through three bidirectional links: two to children nodes and one to a parent node.

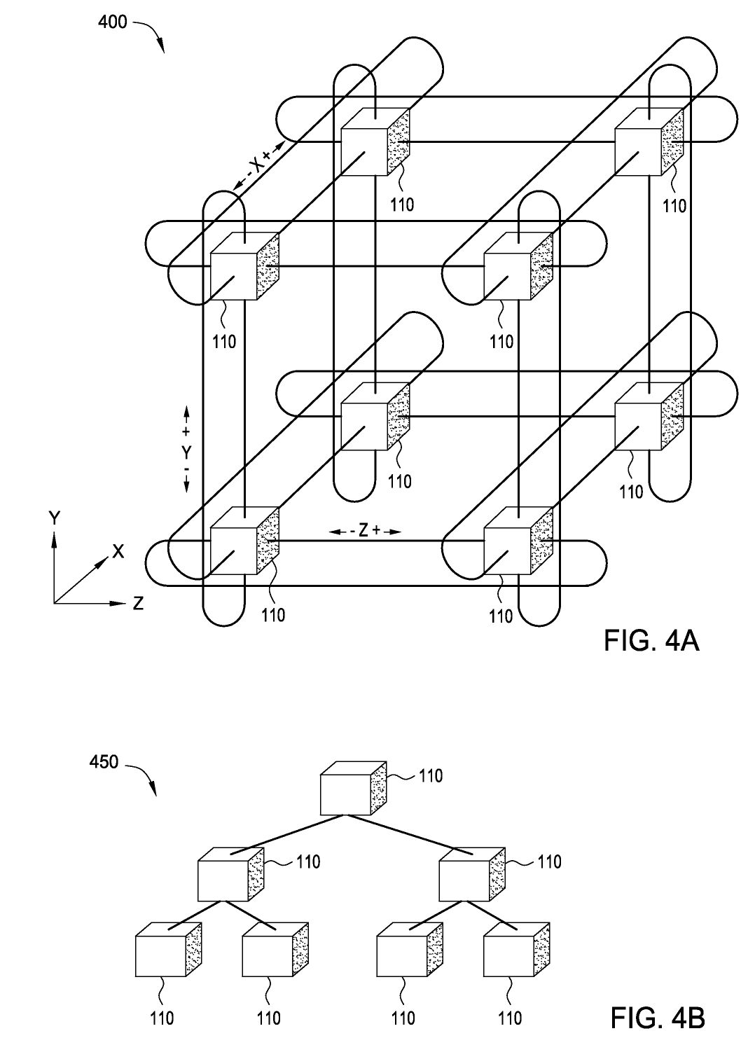

FIGS. 4A-4B are conceptual diagrams illustrating topologies of compute node interconnections in a massively parallel computer system, according to one embodiment of the invention. FIG. 4A shows a 2×2×2 torus 400—a simple 3D nearest-neighbor interconnect that is “wrapped” at the edges. All neighboring compute nodes 110 are equally distant, except for generally negligible “time-of-flight” differences, making code easy to write and optimize.

In one embodiment, torus network 400 supports cut-through routing, which enables packets to transit a compute node 110 without any software intervention until a message reaches a destination. In addition, adaptive routing may be used to increase network performance, even under stressful loads. Adaptation allows packets to follow any minimal path to the final destination, allowing packets to dynamically “choose” less congested routes. Another property integrated in the torus network is the ability to do multicast along any dimension, enabling low-latency broadcast algorithms.

FIG. 4B illustrates a simple collective network 450. In one embodiment, arithmetic and logical hardware (ALU 370 of FIG. 2) is built into the collective network adapter 345 to support integer reduction operations including min, max, sum, bitwise logical OR, bitwise logical AND, and bitwise logical XOR. The collective network 450 may also be used for global broadcast of data, rather than transmitting it around in rings on the torus network 400. For one-to-all communications, this may provide a substantial improvement from a software point of view over torus network 400. The broadcast functionality is also very useful when there are one-to-all transfers that must be concurrent with communications over the torus network 400. Of course, a broadcast can also be handled over the torus network 400, but it involves significant synchronization effort and has a longer latency. The bandwidth of torus network 400 can exceed collective network 450 for large messages, leading to a crossover point at which the torus network becomes the more efficient network for a particular multicast message. The collective network 450 may also be used to forward file-system traffic to I/O nodes 112, which are identical to the compute nodes 110 with the exception that the gigabit Ethernet is wired out to external systems for connectivity with file servers 130 and other systems.

### Efficient Deferred Interrupt Handing in a Parallel Computing Environment

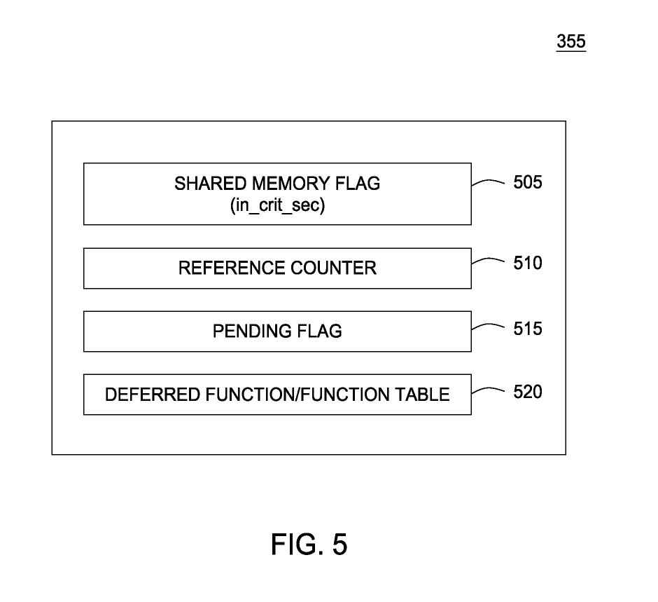

FIG. 5 illustrates elements of a state data structure 360 used for deferred interrupt handling in a parallel computing environment, according to one embodiment of the invention. As shown, state data structure 360 includes a shared memory flag 505, a reference count 510, a pending flag 515 and a deferred function or function table 520. In one embodiment, when a user application 350 enters a critical section of code (i.e., a non-reentrant sequence) a fast user-space function may be invoked to set shared memory flag 505. Thereafter, while traversing the critical section, the shared memory flag 505 “in_crit_section” indicates that the user application 350 is currently inside a critical section of code.

Additionally, the user space function setting the shared memory flag 505 may register a function, i.e., deferred function 520, to invoke once the user application exits the critical section. In the event that different types of interrupts are available, user application 350 may register a table of functions, one for each type of interrupt that might be deferred while user application 350 is inside a critical section. Reference counter 510 may be used to track how “deep” within multiple critical sections a user application might be at any given point of execution. That is, one critical section may include calls to another function with its own critical section. Thus, the critical section “lock” created by shared memory flag 505 may be “locked” multiple times.

In the event an interrupt is delivered while shared memory flag 505 is active, handling of the interrupt is deferred until all critical sections have completed executing. At the same time, if an interrupt occurs, processing of the interrupt is deferred and pending flag 515 may be set. When user application 350 exits a critical section, the pending flag 515 may be checked, and if set, then the deferred function 520 may be invoked to begin the deferred processing of the interrupt delivered while user application 350 was inside a critical section.

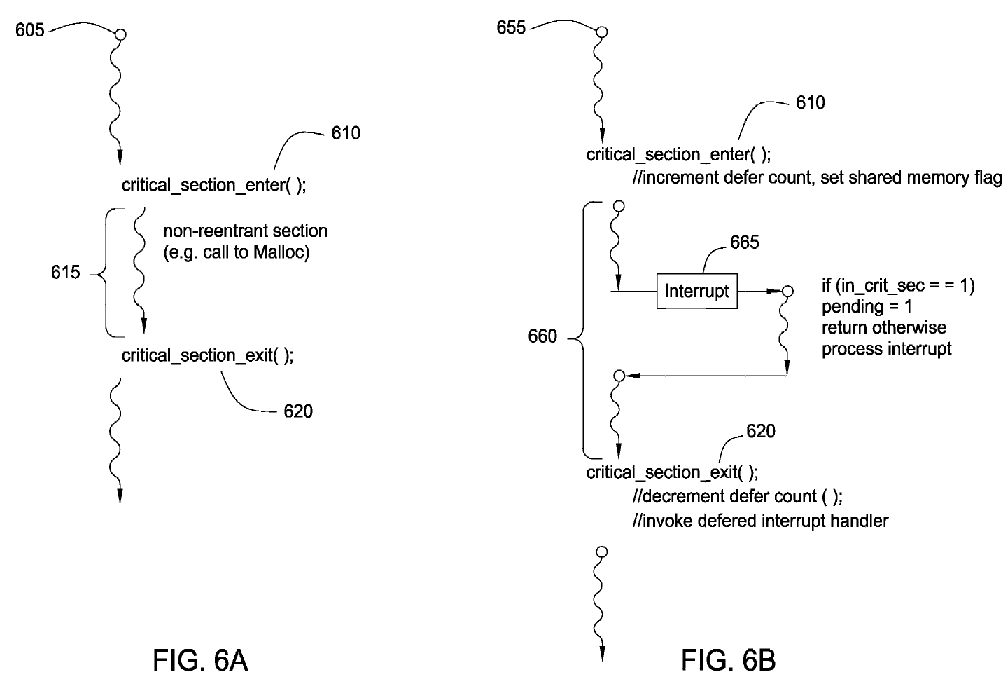

FIGS. 6A-6B illustrate processing flow for a thread executing on a compute node 110 of a massively parallel computer system 100, according to one embodiment of the invention. FIG. 6A shows the execution of a thread 605 through a critical section 615. Upon entry to the critical section 615, a user level function call critical_section_enter( ) 610 is invoked to set shared memory flag 505 and to register deferred function 520. Upon exit from the critical section 615, a user level function call critical_section_exit( ) 620 is invoked to clear shared memory flag 505 and to check the pending flag 515. Illustratively, no interrupt occurs while thread 605 is inside critical section 615. However, critical sections are protected at the minimal overhead of two user-level function calls.

FIG. 6B shows the execution of a thread 655 through a critical section 660. Unlike the flow illustrated in FIG. 6A, an interrupt 665 is delivered while the thread 655 is inside critical section 660. The shared memory flag 505 was set when thread 655 entered critical section 660. Accordingly, in one embodiment, the processing of interrupt 665 is deferred. The pending flag 515 is set to indicate that an interrupt occurred while thread 655 was inside critical section 660. Upon exit from the critical section, the call to critical_section_exit( ) determines that the pending flag 515 was set and invokes the deferred function 520.

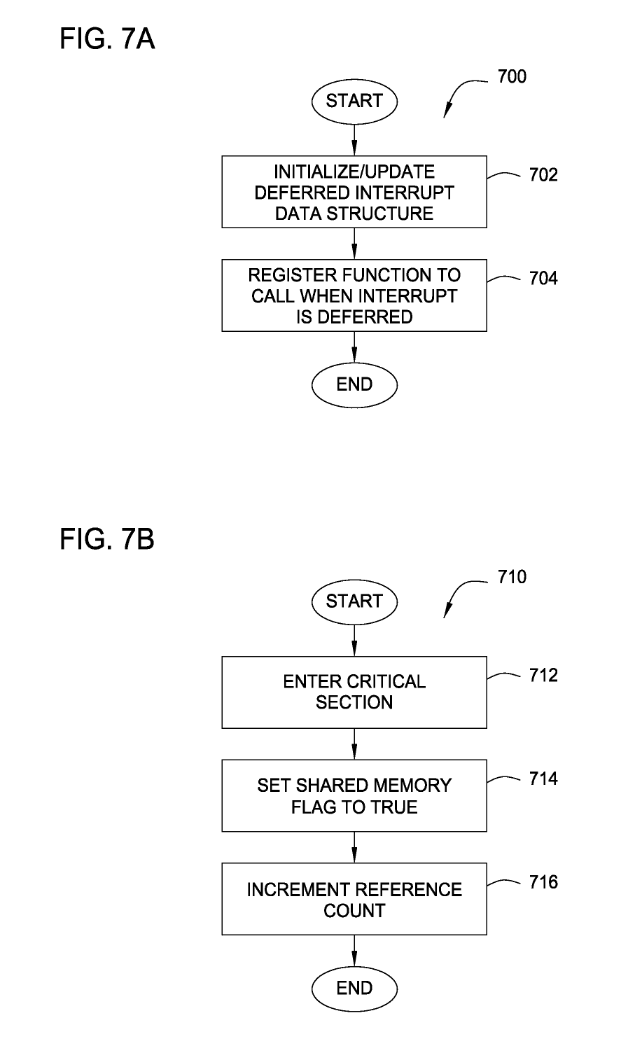

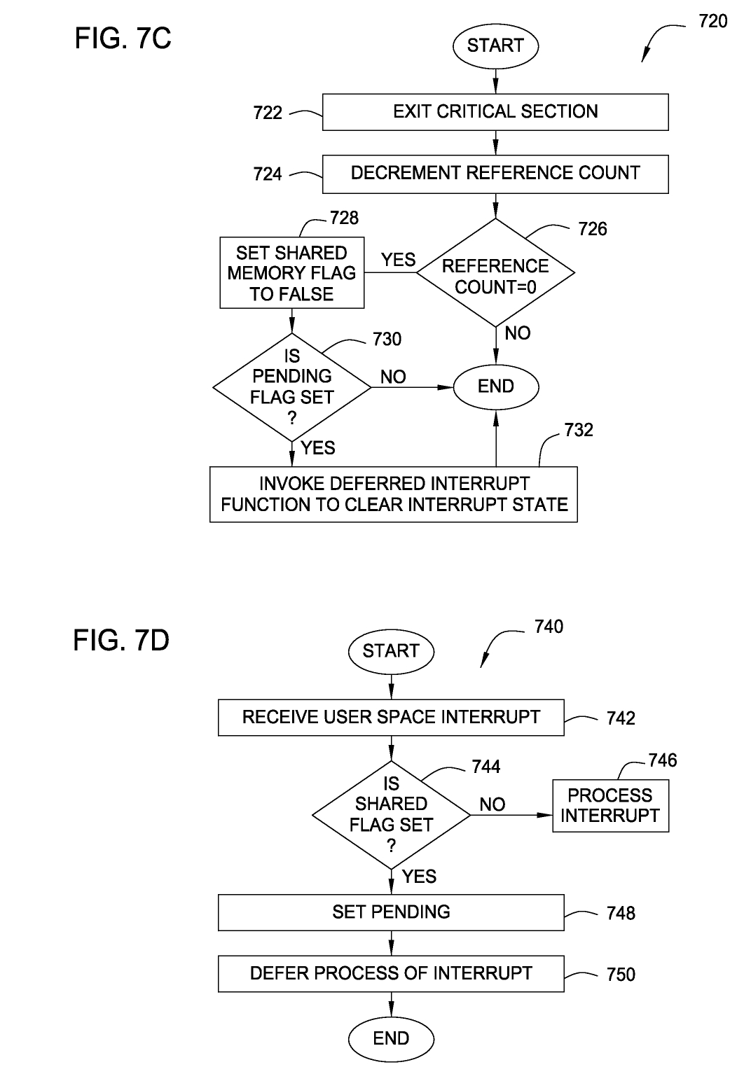

FIGS. 7A-7D illustrate aspects of a method for deferred interrupt handling in a parallel computing environment, according to one embodiment of the invention. The methods shown in FIGS. 7A-7D generally illustrate the deferred interrupt handling shown for threads 605 and 655 in FIGS. 6A-B. FIG. 7A illustrates the actions of a user application 350 to prepare to defer interrupts while executing critical sections of code. The method 700 begins at step 702 where shared memory flag 505, reference count 510 and pending flag 515 of shared state structure 360 are initialized. In one embodiment, these elements of state structure 360 are initialized as global variables, in scope to any code executing on compute node 110. At step 704, a deferred function 520 may be registered to process an interrupt delivered while executing a critical section.

FIG. 7B illustrates actions that may be performed by a user space function (e.g., the critical_section_enter( ) function 610) that may be invoked upon entry to a critical section. The method 710 begins at step 712 where an executing thread enters a critical section. At step 714, the shared memory flag 305 is set, and at step 716, reference count 510 may be incremented.

FIG. 7C illustrates actions that may be performed by a user space function (e.g., the critical_section_exit( ) function 620) that may be invoked upon exit from a critical section. The method 720 beings at step 722 where an executing thread enters reaches the end of a critical section. At step 722, the reference count 510 is decremented. At step 726, if the reference counter has reached “0” (i.e., all critical sections have completed) then at step 728, the shared memory flag 505 is cleared. If the shared memory flag 505 is cleared, then at step 730, it may be determined whether pending flag 515 was set while the executing thread was inside a critical section. If so, the deferred interrupt function 520 is invoked to clear the interrupt state.

FIG. 7D illustrates deferred interrupt handling while an executing thread is inside a critical section of code, according to one embodiment of the invention. The method 740 begins at step 742 when an interrupt is delivered to an thread executing on a compute node 110. At step 744, the thread may determine whether the shared flag 505 is set. If not, the interrupt may be delivered and processed in a conventional manner at step 746. Otherwise, at step 748, the pending flag 515 is set and control is returned back to the executing thread at 750, allowing it to complete execution of the critical section.

### Fast Interrupt Disabling and Processing in a Parallel Computing Environment

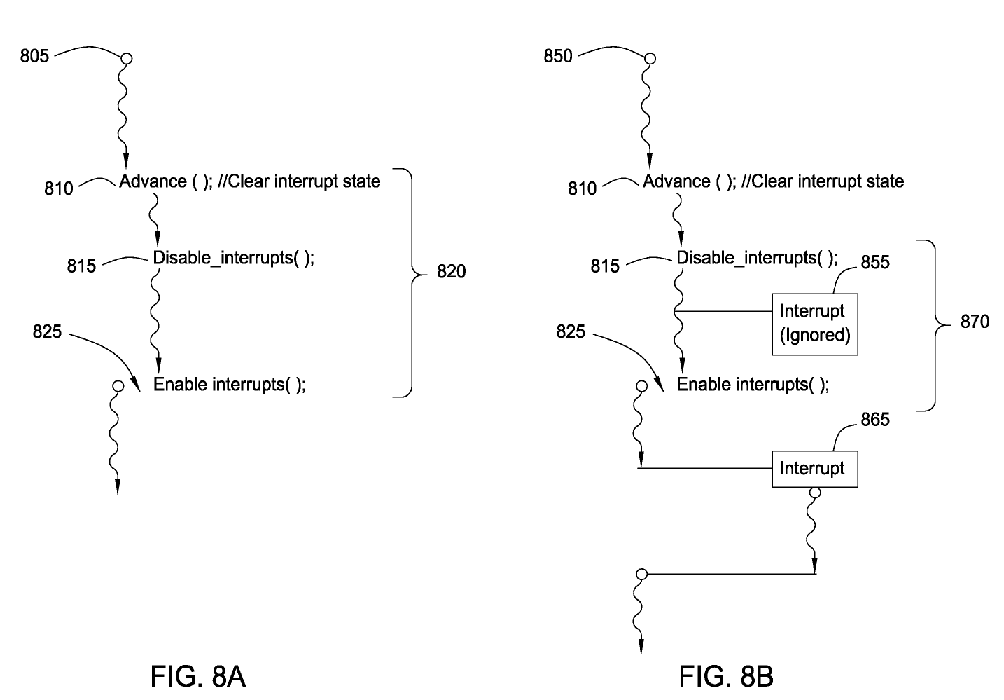

FIGS. 8A-8B illustrate processing flow for a thread executing on a compute node 110 of a massively parallel computer system 100, according to one embodiment of the invention. FIG. 8A shows the execution of a thread 805 through a critical section 820. Upon entry to a function 810 advance( ) that will clear interrupt state, a system level function call 815 is invoked to disable interrupts. While disabled, any interrupts delivered to thread 805 are simply ignored. Thus, critical section 820 may be safely executed. Upon exit from the critical section 820, a system call 825 is invoked to re-enable interrupts. Thread 805 then continues executing. Illustratively, no interrupt occurs while thread 805 is inside critical section 820.

FIG. 8B shows the execution of a thread 850 through a critical section 870. Upon entry to a function 810 (illustratively, an advance( ) function configured to poll network hardware for incoming data packets), a system level function call 815 is invoked to disable interrupts. While disabled, any interrupts delivered to thread 805 are simply ignored. Thus, critical section 870 may be safely executed. Upon exit from the critical section 820, a system call 825 is invoked to re-enable interrupts. Thread 850 then continues executing. Illustratively, an interrupt 855 occurs while thread 850 is inside critical section 870. However, because interrupts were disabled by function 815, interrupt 855 is not delivered to thread 850, and is instead ignored. Because the network hardware preserves interrupt state and will continually deliver the interrupt until the condition that caused the interrupt is cleared. Accordingly, once interrupts are re-enabled by function 825, interrupt 855 is redelivered as interrupt 865, which may now be processed by thread 850.

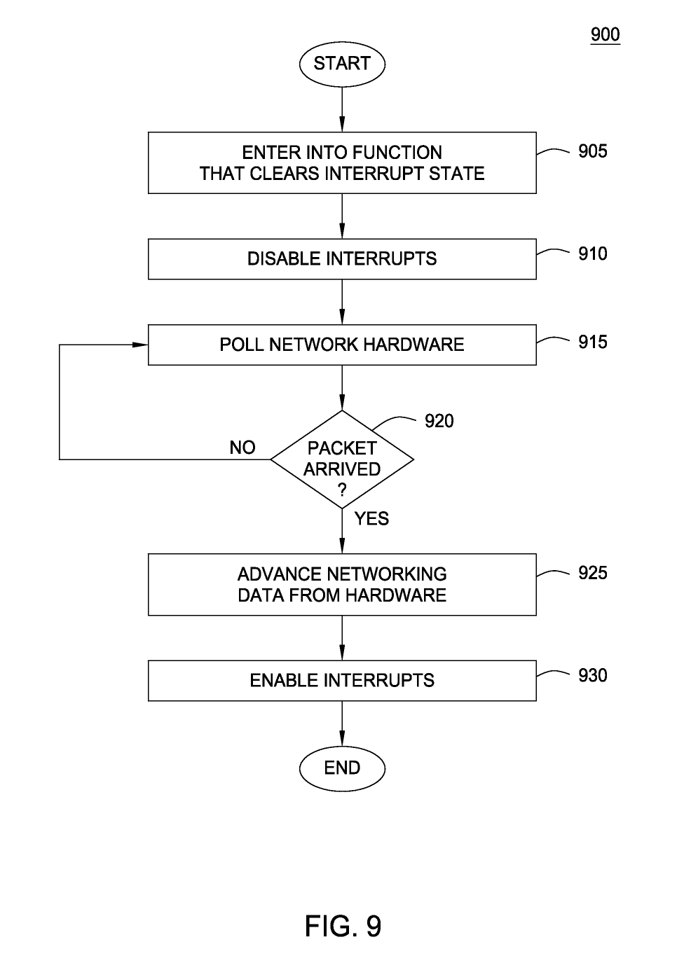

FIG. 9 illustrates a method 900 for fast interrupt disabling and processing in a parallel computing environment, according to one embodiment of the invention. The method shown in FIG. 9 generally illustrates the fast interrupt disabling shown for threads 805 and 850 in FIGS. 8A-8B. The method 900 begins at step 905 where a thread of execution on compute node 110 invokes a function that clears interrupt state. At step 910, a system level function call is invoked to disable interrupts. Once disabled, the critical section of code may be executed. More specifically, at step 915, the network hardware may be polled to determine whether an incoming data packet has arrived. In one embodiment, the polling may continue until a packet is received (step 920). At step 925, once a packet is available, the network data is advanced from the hardware and stored in memory 215 for use by application 350. At step 930, once the function that that clears interrupt state has competed executing, interrupts may be re-enabled at step 930.

Advantageously, as described above, embodiments of the invention provide techniques for protecting critical sections of code being executed in a lightweight kernel environment. These techniques operate very quickly and avoid the overhead associated with a full kernel mode implementation of a network layer, while also allowing network interrupts to be processed without corrupting shared memory state.

While the foregoing is directed to embodiments of the present invention, other and further embodiments of the invention may be devised without departing from the basic scope thereof, and the scope thereof is determined by the claims that follow.

What is claimed is:

1. A method for deferred interrupt handling by a compute node running a user application in a parallel computing environment, comprising:
initializing a shared memory state data structure;
registering a deferred function to process an interrupt received while the user application is executing a wherein the critical section of code includes at least an instruction that modifies a shared memory value; and
upon entering the critical section, setting a shared memory flag of the shared memory data structure to indicate that the user application is currently inside the critical section.

2. The method of claim 1, wherein the critical section includes a call to a non-reentrant function.

3. The method of claim 1, wherein processing an interrupt while executing the critical section would corrupt a memory state of the shared memory value.

4. The method of claim 1, further comprising:
while executing the critical section, receiving an interrupt;
setting a pending flag of the shared memory state data structure; and
deferring processing of the interrupt until the critical section has completed executing.

5. The method of claim 4, further comprising, incrementing a reference count of the shared memory state data structure.

6. The method of claim 1, further comprising:
upon exit from the critical section, clearing the shared memory flag;
evaluating a pending flag of the shared memory data structure; and
if the pending flag indicates that an interrupt was deferred while executing the critical section, invoking the deferred function to clear the interrupt.

7. The method of claim 6, further comprising, decrementing a reference count of the shared memory state data structure.

8. The method of claim 1, wherein registering a deferred function comprises registering a table of functions, wherein each function is associated with a different type of interrupt.

9. A computer-readable medium containing a program which, when executed, performs an operation for deferred interrupt handling by a compute node running a user application in a parallel computing environment, comprising:
initializing a shared memory state data structure;
registering a deferred function to process an interrupt received while the user application is executing a critical section wherein the critical section of code includes at least an instruction that modifies a shared memory value; and
upon entering the critical section, setting a shared memory flag of the shared memory data structure to indicate that the user application is currently inside a critical section.

10. A system, comprising:
a compute node having a at least one processor;
a memory coupled to the compute node and configured to store, a shared memory data structure and a lightweight kernel; and
a user application configured to:
initialize a shared memory state data structure;
register a deferred function to process an interrupt received while the user application is executing a critical section, wherein the critical section of code includes at least an instruction that modifies a shared memory value; and
upon entering the critical section, set a shared memory flag of the shared memory data structure to indicate that the user application is currently inside a system section.

11. A method for deferred interrupt handling by a compute node running a user application in a parallel computing environment, comprising:
initializing a shared memory state data structure;
registering a deferred function to process an interrupt received while the user application is executing a critical section, wherein the critical section of code includes at least an instruction that modifies a shared memory value;
upon entering the critical section, setting a shared memory flag of the shared memory data structure to indicate that the user application is currently inside the critical section;
upon exit from the critical section, clearing the shared memory flag;
evaluating a pending flag of the shared memory data structure; and
if the pending flag indicates that an interrupt was deferred while executing the critical section, invoking the deferred function to clear the interrupt.

12. The computer-readable medium of claim 9, wherein the critical section includes a call to a non-reentrant function.

13. The computer-readable medium of claim 9, wherein processing an interrupt while executing the critical section would corrupt a memory state of the shared memory value.

14. The computer-readable medium of claim 9, wherein the operations further comprise:
while executing the critical section, receiving an interrupt;
setting a pending flag of the shared memory state data structure; and
deferring processing of the interrupt until the critical section has completed executing.

15. The computer-readable medium of claim 12, wherein the operations further comprise, incrementing a reference count of the shared memory state data structure.

16. The computer-readable medium of claim 9, wherein the operations further comprise:
upon exit from the critical section, clearing the shared memory flag;
evaluating a pending flag of the shared memory data structure; and
if the pending flag indicates that an interrupt was deferred while executing the critical section, invoking the deferred function to clear the interrupt.

17. The computer-readable medium of claim 14, wherein the operations further comprise, decrementing a reference count of the shared memory state data structure.

18. The computer-readable medium of claim 9, wherein registering a deferred function comprises registering a table of functions, wherein each function is associated with a different type of interrupt.

19. A system, comprising:
a compute node having at least one processor;
a memory coupled to the compute node and configured to store, a shared memory data structure and a lightweight kernel; and
a user application configured to:
initialize a shared memory state data structure;
register a deferred function to process an interrupt received while the user application is executing a critical section, wherein the critical section of code includes at least an instruction that modifies a shared memory value; and
upon entering the critical section, set a shared memory flag of the shared memory data structure to indicate that the user application is currently inside the critical section.

20. The method of claim 17, wherein the critical section includes a call to a non-reentrant function.

21. The system of claim 17, wherein processing an interrupt while executing the critical section would corrupt a memory state of the shared memory value.

22. The system of claim 17, wherein the user application is further configured, in response to receiving an interrupt while executing the critical section:
to set a pending flag of the shared memory state data structure; and
to defer processing of the interrupt until the critical section has completed executing.

23. The system of claim 20, wherein the user application is further configured to increment a reference count of the shared memory state data structure for each interrupt received while executing the critical section.

24. The system of claim 17, wherein the user application is further configured to:
upon exit from the critical section, clear the shared memory flag;
evaluate a pending flag of the shared memory data structure; and
if the pending flag indicates that an interrupt was deferred while executing the critical section, invoke the deferred function to clear the interrupt.

25. The system of claim 22, wherein the user application is further configured, to decrement a reference count of the shared memory state data structure upon exit from the critical section.

26. The system of claim 17, wherein the user application is further configured to register a table of functions, wherein each function is associated with a different type of interrupt.

27. A method for deferred interrupt handling by a compute node running a user application in a parallel computing environment, comprising:
initializing a shared memory state data structure;
registering a deferred function to process an interrupt received while the user application is executing a critical section, wherein the critical section of code includes at least an instruction that modifies a shared memory value;
upon entering the critical section, setting a shared memory flag of the shared memory data structure to indicate that the user application is currently inside the critical section;
upon exit from the critical section, clearing the shared memory flag;
evaluating a pending flag of the shared memory data structure; and
if the pending flag indicates that an interrupt was deferred while executing the critical section, invoking the deferred function to clear the interrupt.
